(19) United States
(12) Patent Application Publication
(10) Pub. No.: US 2009/0225999 A1
(43) Pub. Date: Sep. 10, 2009

(54) Method for cancelling TDD noise and stereo headphone employing the same

(75) Inventor: Duck Soo Lee, Seoul (KR)

Correspondence Address: THE NATH LAW GROUP, 112 South West Street, Alexandria, VA, 22314, US

(73) Assignee: NEOFIDELITY, INC.

(21) Appl. No.: 12/073,395

(22) Filed: Mar. 5, 2008

(51) Int. Cl. H04R 1/10

(52) U.S. Cl. 381/74

(57) ABSTRACT

A method for canceling a TDD noise and a stereo headphone employing the same are disclosed. In accordance with the method and the stereo headphone, an audio signal is applied to speakers through a virtual ground single-ended structure and a voice call signal is applied to the speakers via a BTL structure by turning on and turning off a virtual ground terminal to cancel the TDD noise and eliminate a need for a DC blocking capacitor.

### BACKGROUND OF THE INVENTION

1. Field of the Invention

The present invention relates to a method for canceling a TDD noise and a stereo headphone employing the same, and in particular, to a method for canceling a TDD noise and a stereo headphone employing the same wherein an audio signal is applied via a virtual ground single-ended structure and a voice call signal is applied via a BTL structure by turning on and turning off a virtual ground terminal to cancel the TDD noise.

2. Description of the Related Art

A TDD (Time Division Duplex) communication is a bidirectional communication using a single frequency wherein each frame is divided into a transmission portion and a reception portion. While a wireless communication uses generally different frequencies for a transmission and reception, the TDD communication uses the single frequency in a time-divisional manner by dividing each frame into the transmission portion and the reception portion.

The TDD communication is used in a GSM (Global System for Mobile Telecommunication), wherein the communication is carried out by dividing each frame by 4ms time period. While the communication seems to be bidirectional due to the division by a short time period, only the transmission or the reception is carried out for each time period.

In addition, current consumptions alternately occur during the transmission and the reception, resulting in a ripple at a power supply stage due to a difference in the current consumptions. The ripple is referred to as a TDD noise wherein a level of the TDD noise is in a 217 Hz band which is audible to human ears.

FIG. 1 is a circuit diagram illustrating a conventional stereo headphone.

Referring to FIG. 1, the conventional stereo headphone comprises a first speaker 20a and a second speaker 20b.

The first speaker 20a and the second speaker 20b converts a signal such as an audio signal or a voice call signal applied to input terminals thereof into a signal in an audible frequency range.

When the audio signal (for instance, a stereo signal from a playback of an MP3 file) is applied, the TDD communication is not carried out. Therefore, the TDD noise is not generated, resulting in a clear and high quality sound. However, when the voice call signal is applied, the TDD communication is carried out. Therefore, the TDD noise is generated, resulting in a noisy and a low quality sound.

That is, when the voice call signal is transceived, a time period for transceiving a wireless signal between a base station and a terminal is required, and a power consumption of a larger value occurs during the time period compared to that of playing back the audio signal. The similar applies to the TDD communication.

### SUMMARY OF THE INVENTION

It is an object of the present invention to provide a method for canceling a TDD noise and a stereo headphone employing the same wherein an audio signal is outputted thorough a virtual ground single-ended structure by turning on the virtual ground terminal and a voice call signal is outputted through a BTL structure to remove the TDD noise included in the voice call signal.

In order to achieve the above-described object, there is provided a stereo headphone comprising: a first speaker and a second speaker serially connected, a common terminal of the first speaker and the second speaker being connected to a virtual ground terminal; and a controller for applying a left signal and a right signal to input terminals of the first speaker and the second speaker respectively when an audio signal is applied, and inverting one of the left signal and the right signal and applying the inverted signal and the non-inverted signal to the input terminals of the first speaker and the second speaker respectively when a voice call signal is applied, wherein the controller turns on the virtual ground terminal when the audio signal is applied and turns off the virtual ground terminal when the voice call signal is applied.

Preferably, the stereo headphone further comp comprises a virtual ground circuit for providing the virtual ground terminal.

It is preferable that the virtual ground terminal comprises: a bias circuit for outputting a constant DC voltage; and a voltage follower circuit for outputting a voltage substantially identical to the constant DC voltage.

Preferably, the stereo headphone further comprises an amplifier connected between the first speaker and the second speaker, and the controller.

Preferably, the audio signal is provided via a virtual ground single-ended structure and the voice call signal is provided via a BTL structure.

It is preferable that a noise signal included in the voice call signal is removed by using a BTL structure when the virtual ground terminal is turned off.

In order to achieve the above-described object, there is also provided a method for driving a stereo headphone, the method comprising turning on a virtual ground terminal connected to a common terminal when an audio signal is applied to input terminals of a first speaker and a second speaker serially connected, and turning off the virtual ground terminal connected to the common terminal when a voice call signal is applied to the input terminals of the first speaker and the second speaker.

Preferably, an inverted voice call signal is applied to one of the input terminals of the first speaker and the second speaker.

Preferably, the audio signal is applied via a virtual ground single-ended structure and the voice call signal is applied via a BTL structure.

Preferably, a noise signal included in the voice call signal is removed by using a BTL structure when the virtual ground terminal is turned off.

### BRIEF DESCRIPTION OF THE DRAWINGS

FIG. 1 is a circuit diagram illustrating a conventional stereo headphone.

FIG. 2 is a circuit diagram illustrating a stereo headphone capable of canceling a TDD noise in accordance with the present invention.

FIG. 3 is a circuit diagram illustrating a virtual ground circuit of a stereo headphone in accordance with the present invention.

FIG. 4 is a flow diagram illustrating a method for canceling a TDD noise in accordance with the present invention.

### DETAILED DESCRIPTION OF THE INVENTION

The above-described objects and other objects and characteristics and advantages of the present invention will now be described in detail with reference to the accompanied drawings.

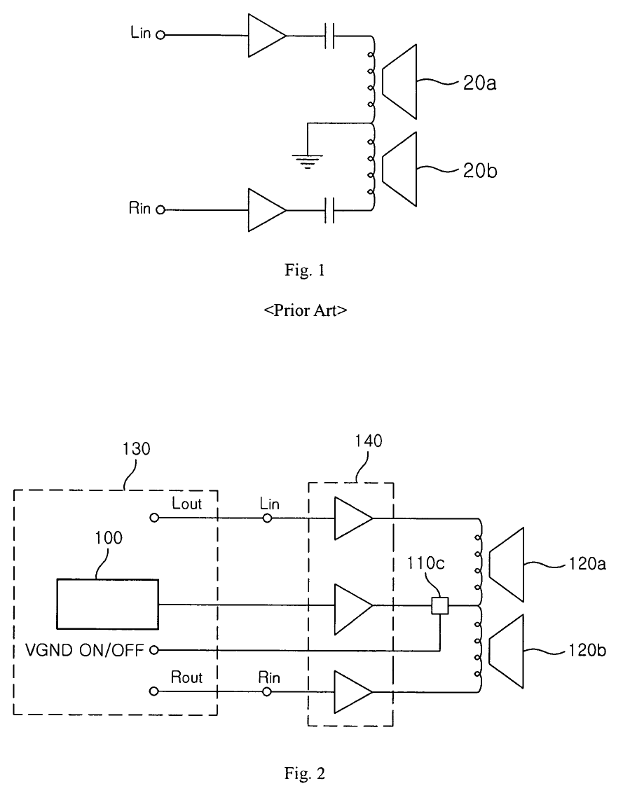

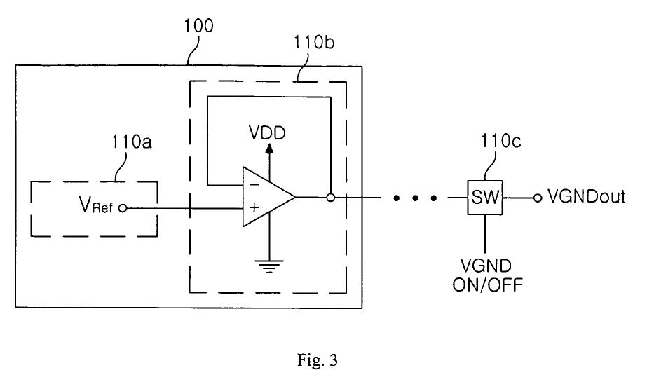

FIG. 2 is a circuit diagram illustrating a stereo headphone capable of canceling a TDD noise in accordance with the present invention, and FIG. 3 is a circuit diagram illustrating a virtual ground circuit of a stereo headphone in accordance with the present invention.

Referring to FIG. 2, the stereo headphone capable of canceling the TDD noise in accordance with the present invention comprises a first speaker 120a and a second speaker 120b serially connected and a controller 130. The stereo headphone may further comprise an amplifier 140.

The first speaker 120a and the second speaker 120b converts a signal applied to input terminals thereof as a signal in an audible frequency range.

When an audio signal including a left signal Lin and a right signal Rin (for instance, a stereo signal) is received, the controller 130 applies the left signal Lin and the right signal Rin to the first speaker 120a and the second speaker 120b respectively via the amplifier 140. When the audio signal is applied, the controller 130 generates a VGND ON signal to turn on the virtual ground terminal 110c.

The virtual ground terminal 110c is connected to a virtual ground circuit 100 included in the controller 130.

An example of the virtual ground circuit 100 is shown in FIG. 3.

Referring to FIG. 3, the virtual ground circuit 100 comprises a bias circuit 110a and a voltage follower circuit 110b.

The bias circuit 110a generates and applies a reference voltage Vref to a non-inverting input terminal of an operational amplifier.

The voltage follower circuit 110b is a negative feedback circuit wherein a voltage identical to the reference voltage Vref applied to the non-inverting input terminal of the operational amplifier appears at an output terminal thereof. Therefore, the reference voltage Vref appears at a terminal VGNDOut or the terminal VGNDOut is at a high-impedance state according to ON and OFF of the virtual ground terminal 110c.

As the reference voltage Vref is applied to a common terminal of the first speaker 120a and the second speaker 120b, a DC blocking capacitor which is required in a conventional single-ended output structure is not needed.

That is, in accordance with a conventional single-ended output structure, the DC blocking capacitor is required because the common terminal of the first speaker 120a and the second speaker 120b is connected to GND, i.e., 0V. However, in accordance with the virtual ground single-ended output structure of the present invention, the DC blocking capacitor is not required because the common terminal of the first speaker 120a and the second speaker 120b is connected to VGNDOut having a constant voltage.

Referring back to FIG. 2, when a voice call signal (for instance, a mono signal generated during a voice call) is received, the controller 130 applies the voice call signal to the first speaker 120a and the second speaker 120b through the amplifier 140. Specifically, the controller 130 inverts one of the signal Lin and the signal Rin and applies the voice call signal including the inverted signal to the first speaker 120a and the second speaker 120b, respectively.

For instance, the controller 130 applies the signal Lin to the first speaker 120a and a signal obtained by inverting the signal Rin to the second speaker 120b. Alternately, the controller 130 applies a signal obtained by inverting the signal Lin to the first speaker 120a and the signal Rin to the second speaker 120b. When the voice call signal is applied, the controller 130 generates a VGND OFF signal to turn off the virtual ground terminal 110c. When the virtual ground terminal 110c is turned off, output stages of the first speaker 120a and the second speaker 120b form a BTL (Bridge Tied Load) structure.

That is, since only one of the first speaker 120a and the second speaker 120b receives the inverted signal, the signals inputted to the first speaker 120a and the second speaker 120b form a differential signal. Therefore, an in-phase noise generated during the voice call is cancelled to provide the voice call having an improved sound quality.

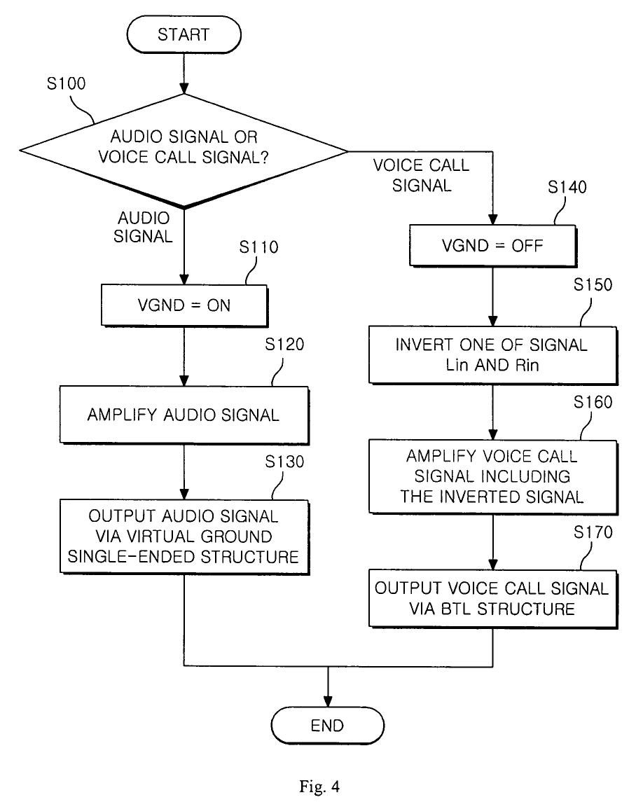

FIG. 4 is a flow diagram illustrating a method for canceling a TDD noise in accordance with the present invention.

Referring to FIG. 4, whether a signal applied to input terminals of a first speaker and a second speaker is an audio signal or a voice call signal is determined (S100).

When the signal applied to the input terminals of the first speaker and the second speaker is the audio signal, the virtual ground terminal is turned on (S110).

Thereafter, the audio signal including a left signal and a right signal is amplified (S120).

Thereafter, the amplified audio signal is outputted through the first speaker and the second speaker (S130). Since the virtual ground terminal is turned on, the audio signal is outputted through a virtual ground single-ended structure.

When the signal applied to the input terminals of the first speaker and the second speaker is the voice call signal, the virtual ground terminal is turned off (S140).

Thereafter, the voice call signal is applied to the first speaker and the second speaker in a manner that one of a signal Lin and a signal Rin is inverted (S150). For instance, the signal Lin is applied to the input terminal of the first speaker and a signal obtained by inverting the signal Rin is applied to the input terminal of the second speaker. Alternately, a signal obtained by inverting the signal Lin is applied to the input terminal of the first speaker and the signal Rin is applied to the input terminal of the second speaker.

Thereafter, the voice call signal including the inverted signal is amplified (S160).

Thereafter, the amplified voice call signal is outputted through the first speaker and the second speaker (S170). Since the virtual ground terminal is turned off, the voice signal is outputted through a BTL structure. Therefore, an in-phase noise generated during the voice call is cancelled to provide the voice call having an improved sound quality.

As described above, the method for canceling the TDD noise and the stereo headphone employing the same are advantageous in that the capacitor is not required at the output stage by using the virtual ground terminal. In addition, the method for canceling the TDD noise and the stereo headphone employing the same are advantageous in that the TDD noise is removed by outputting the audio signal via the virtual ground single-ended structure when the virtual ground terminal is turned on and outputting the voice call signal via the BTL structure through the first speaker and the second speaker forming the BTL structure when the virtual ground terminal is turned off.

What is claimed is:

1. A stereo headphone comprising:
a first speaker and a second speaker serially connected, a common terminal of the first speaker and the second speaker being connected to a virtual ground terminal; and
a controller for applying a left signal and a right signal to input terminals of the first speaker and the second speaker respectively when an audio signal is applied, and inverting one of the left signal and the right signal and applying the inverted signal and the non-inverted signal to the input terminals of the first speaker and the second speaker respectively when a voice call signal is applied,
wherein the controller turns on the virtual ground terminal when the audio signal is applied and turns off the virtual ground terminal when the voice call signal is applied.

2. The stereo headphone in accordance with claim 1, further comprising a virtual ground circuit for providing the virtual ground terminal.

3. The stereo headphone in accordance with claim 1, wherein the virtual ground terminal comprises:
a bias circuit for outputting a constant DC voltage; and
a voltage follower circuit for outputting a voltage substantially identical to the constant DC voltage.

4. The stereo headphone in accordance with claim 1, further comprising an amplifier connected between the first speaker and the second speaker, and the controller.

5. The stereo headphone in accordance with claim 1, wherein the audio signal is provided via a virtual ground single-ended structure and the voice call signal is provided via a BTL structure.

6. The stereo headphone in accordance with claim 1, wherein a noise signal included in the voice call signal is removed by using a BTL structure when the virtual ground terminal is turned off.

7. A method for driving a stereo headphone, the method comprising turning on a virtual ground terminal connected to a common terminal when an audio signal is applied to input terminals of a first speaker and a second speaker serially connected, and turning off the virtual ground terminal connected to the common terminal when a voice call signal is applied to the input terminals of the first speaker and the second speaker.

8. The method in accordance with claim 7, wherein an inverted voice call signal is applied to one of the input terminals of the first speaker and the second speaker.

9. The method in accordance with claim 7, wherein the audio signal is applied via a virtual ground single-ended structure and the voice call signal is applied via a BTL structure.

10. The method in accordance with claim 7, wherein a noise signal included in the voice call signal is removed by using a BTL structure when the virtual ground terminal is turned off.
